(19) United States
(12) Patent Application Publication
(10) Pub. No.: US 2014/0165465 A1
(43) Pub. Date: Jun. 19, 2014

(54) UTILITY BOX WITH INTERLOCKING LEGS AND ASSOCIATED METHOD

(71) Applicant: Benjamin Ken Watson, South Ogden, UT (US)

(72) Inventor: Benjamin Ken Watson, South Ogden, UT (US)

(21) Appl. No.: 13/716,205

(22) Filed: Dec. 17, 2012

(51) Int. Cl. A01G 9/02

(52) U.S. Cl. CPC A01G 9/02
USPC 47/66.1; 29/464

(57) ABSTRACT

A raised box device includes a first side having a quadrangular panel and a pair of legs extending from the panel. Each of the pair of legs has a notch opening on a similar side of the leg. A second side also has a quadrangular panel and a pair of legs extending from the panel. Each of the pair of legs of the second side has a notch opening on a similar side of the leg. The notch openings on the legs of the second side are oriented opposite the notch openings on the legs of the first side. The notches of the legs of the first side are insertable into the notches of the legs of the second side to interlock the first and second sides and form a utility space between the quadrangular panels of the first and second sides.

### BACKGROUND OF THE INVENTION

1. Field of the Invention

The present invention relates generally to elevated utility boxes and more particularly to boxes used as raised planter boxes having interlocking components that form the sides and legs.

2. Related Art

Elevated boxes can have a wide variety of uses including tool storage, garden supply storage, harvester bins, waste bins, and the like. Some elevated decorative boxes are used as raised planter boxes that create garden beds for plants. Planter boxes are often quadrangular shaped boxes having a flat bottom surrounded by four sides extending upward from the bottom. The space created within the sides and the bottom can form a garden bed in which soil and plants can be placed.

Many boxes are constructed of wood or plastic pieces that are held together with fasteners such as screws or bolts. Unfortunately, such construction methods can create several problems for elevated decorative boxes. For example, a box with many pieces may require many fasteners which can increase the cost of the box. Additionally, boxes with many pieces can be difficult to assemble due to having to hold many pieces at once in place while the fasteners are put in place. Such boxes might require more than one person to assemble, and are often involve time intensive assembly processes.

Another common problem especially for planter boxes is water drainage. Flat bottomed planter boxes can collect water in the bottom which can over-saturate the garden bed. Additionally, left over time, excess water can create mold and mildew problems that can inhibit proper plant growth. Moreover, in the case of wood planter boxes, standing water can rot the wood and cause structural problems for the planter box.

### SUMMARY OF THE INVENTION

The inventor of the present invention has recognized that it would be advantageous to develop a raised box that could be easily assembled without the use of fasteners. Additionally, the inventor has recognized that it would be advantageous to develop a raised box with interlocking panels that form both legs and sides of the box. Furthermore, the inventor has recognized that it would be advantageous to develop a method for forming a raised box without fasteners and having a shape that provides drainage from the bottom of the box.

Accordingly, the invention provides for a raised box device including a first side. The first side can have a quadrangular panel and a pair of legs extending from the panel. Each of the pair of legs can have a notch opening on a similar side of the leg. The raised box device can also include a second side with a quadrangular panel and a pair of legs extending from the panel. Each of the pair of legs of the second side can have a notch opening on a similar side of the leg. The notch openings of the notches on the second side can be oriented opposite the side of the legs having the notches on the legs of the first side. The notches of the legs of the first side can be insertable into the notches of the legs of the second side to form a utility space between the quadrangular panels of the first and second sides. In one aspect, the raised box can be a planter box and the utility space can be a garden bed.

Additionally, the raised box can include a groove located near an end of the quadrangular panel of the first side and a corresponding groove located near an end of the quadrangular panel of the second side. The grooves can be positioned to align together when the first and second sides are joined together. An end panel can be inserted into the grooves of the first and second sides. The end panel can be sized and shaped to close an end of the utility space.

Furthermore, the raised box can include a drain block. The drain block can be sized and shaped to fit in a bottom of the utility space to close off a gap between the quadrangular panel of the first side and the quadrangular panel of the second side.

The present invention also provides for a method for forming a raised box including positioning a first side adjacent a second side. Each of the first and second sides can include a quadrangular panel and a pair of legs extending from the quadrangular panel. Interlocking notches in the pair of legs of the first side can be aligned with corresponding notches in the pair of legs of the second side. The first side can be joined with the second side by inserting the notches on the pairs of legs into one another. The first side and the second side can be oriented at oblique and opposing angles with respect to a support surface such that the quadrangular panels form a utility space supported by the pairs of legs. In one aspect, the raised box can be a planter box and the utility space can be a garden bed.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a perspective view of a planter box device in accordance with an embodiment of the present invention;

FIG. 2 is a front view of the planter box device of FIG. 1;

FIG. 3 is a perspective view of the planter box device of FIG. 1 shown with a pair of end panels partially installed;

FIG. 4 is a perspective view of the planter box device of FIG. 1 shown with the end panels installed;

FIG. 5 is an exploded view of the planter box of FIG. 4;

FIG. 6 is a perspective view of the planter box device of FIG. 4 shown with a partial lid;

FIG. 7 is a perspective view of the planter box device of FIG. 4 shown with a complete lid; and

FIGS. 8-11 illustrate a method for making a planter box device in accordance with an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The embodiments of the present invention described herein generally provide for a raised box that is easy to assemble without the use of fasteners. In one aspect, the raised box can be a planter box having garden bed for planning flowers, vegetables, herbs and the like. The raised box can have a pair of sides that include a quadrangular panel with a pair of legs extending away from the panel. The quadrangular panel can be a solid rectangular or square shaped panel. The pair of legs can extend from opposite ends of the panel a predetermined distance that defines the height of the leg. The pair of legs can have notches that can interlock with corresponding notches in the legs of a mating side. The notches on the legs of one of the sides can have an opening on similar sides of the legs. The notches on the legs of the other of the sides can have an opening on similar sides but on opposite sides from the first side so that the notches in the legs of one of the sides can be slid into the notches in the legs of the other side. When joined together via the notches in the legs, the two sides are oriented at oblique and opposite angles with a respect to a support surface such as the ground. The orientations of the sides with respect to one another forms a utility space between the quadrangular panels of each of the sides. In one aspect, the utility space has a triangular cross section with a triangular prism shaped useful volume. A triangular end piece can be placed on opposite ends of the raised box to close off the useful volume of the utility space. Additionally, a drain block can be placed in the bottom of the useful volume of the utility space to close off a gap between the quadrangular panels of the sides. In the case were the raised box is a planter box, the utility space can form a garden bed suitable for planting flora of all varieties.

Thus, in one exemplary use, the raised box can be a planter box. The planter box can be assembled by aligning the notches in the pairs of legs and sliding the two sides together until the notches interlock with one another, thus forming a utility space between the quadrangular panels of the sides. End caps can be placed on either end of the utility space to enclose the planting volume of the garden bed. The drain block can be placed in the bottom of the planting volume to close the gap between the quadrangular panels of the sides. Soil can then be placed in the planting volume to form a garden bed, and plants such as flowers, vegetables, and the like can be planted in the garden bed. If desired for additional drainage, the gap between the quadrangular panels of the sides can be left open and the utility space can be lined with a porous landscaping cloth that would prevent soil from escaping through the gap but would still allow moisture the drain away from the garden bed.

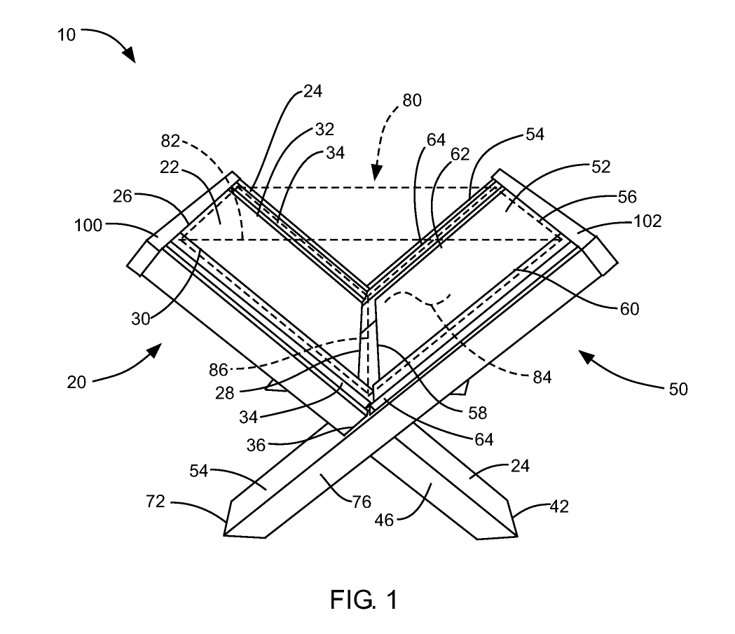

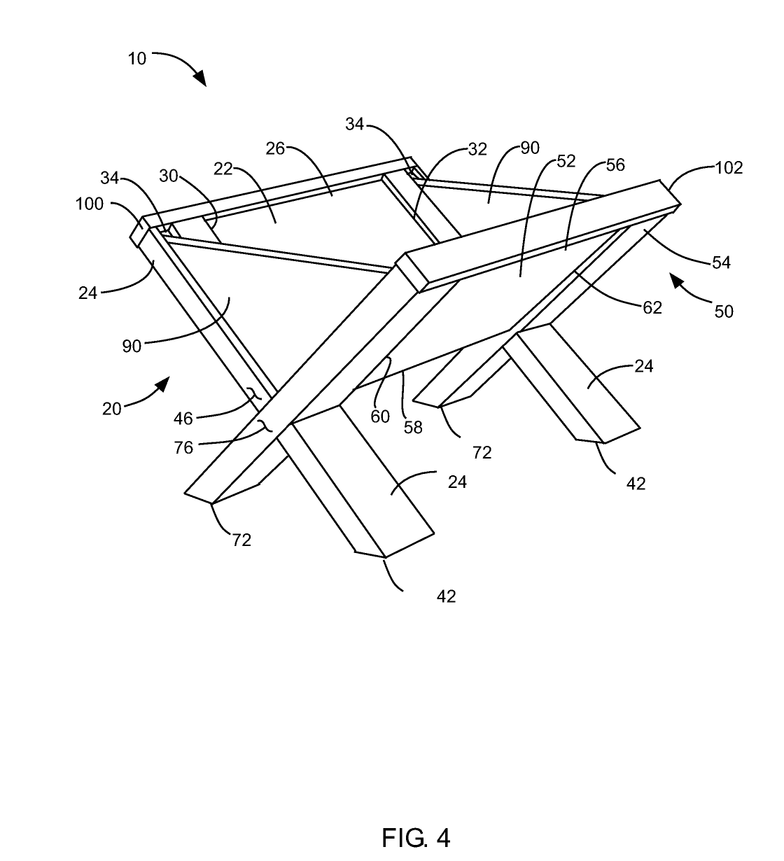

As illustrated in FIGS. 1-5, a raised box device, indicated generally at 10, is shown in accordance with an embodiment of the present invention for use growing plants such as flowers, vegetables and the like. The raised box 10 has a first side, shown generally at 20 and a second side, shown generally at 50 that can be joined together to form a utility space, indicated generally at 80.

The first side 20 can include a quadrangular panel 22 and a pair of legs 24. The quadrangular panel can have an uppermost edge 26 and a lowermost edge 28 disposed between opposite sides 30 and 32 of the panel. Additionally, the quadrangular panel 22 of the first side 20 can have a groove 34 extending along each of the opposite sides of the panel.

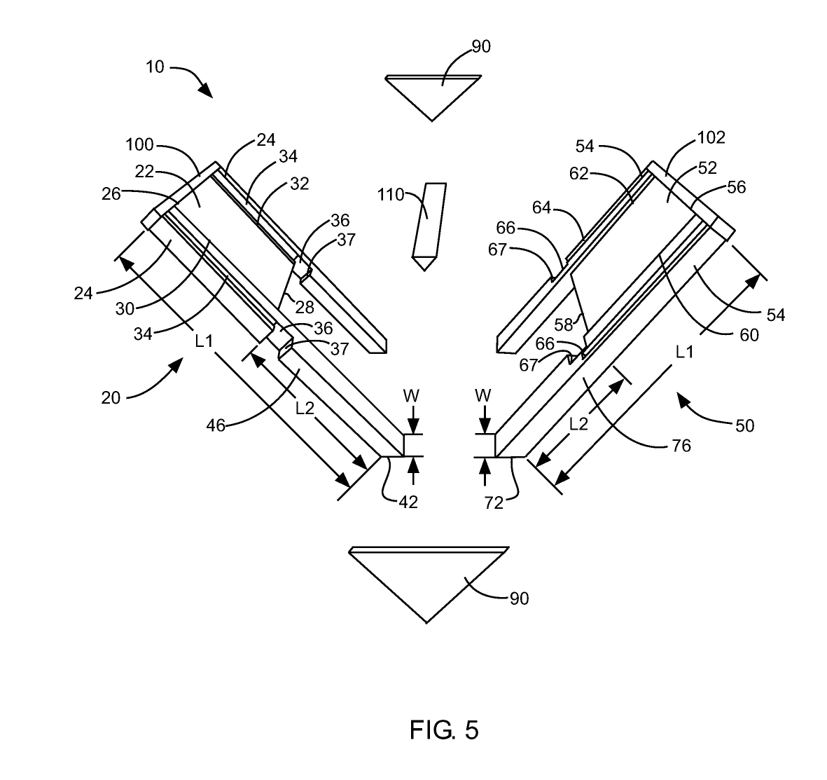

The pair of legs 24 can extend away from the panel a length L1 on opposite sides 30 and 32 of the quadrangular panel 22. As best seen in FIG. 5, each of the pair of legs 24 can have a notch 36 with an opening 38 on a similar side 40 of the legs. The notch 36 can be located on the leg adjacent to the lowermost edge 28 the quadrangular panel with a length L2 of the leg extending beyond the notch to a distal end 42 of the leg.

The second side 50 can also include a quadrangular panel 52 and a pair of legs 54. The quadrangular panel can have an uppermost edge 56 and a lowermost edge 58 disposed between opposite sides 60 and 62 of the panel. Additionally, the quadrangular panel 52 of the second side 50 can have a groove 64 extending along each of the opposite sides of the panel.

The pair of legs 54 can extend away from the panel 52 a length L1 on opposite sides 60 and 62 of the quadrangular panel 52. Each of the pair of legs can have a notch 66 with an opening 68 on a similar side 70 of the legs. The notch can be located on the leg adjacent to the lowermost edge 58 the quadrangular panel with a length L2 of the leg extending beyond the notch to a distal end 72 of the leg.

In one aspect, the first and second sides 20 and 50 can be made of wood with the quadrangular panels 22 and 52 being formed of several slats of wood bounded by the pairs of legs 24 and 54. In another aspect, the first and second sides can be formed of a plastic or thermoplastic type material that can be molded to simulate wood or some other decorative façade. Other materials, as known in the art, that are suitable for construction and having a desired aesthetic can also be used to form the various components of the raised box 10 described herein.

The notches 36 and 66 in the pairs of legs 24 and 54 can interlock with one another to join the first side 20 with the second side 50. The notches 66 in the legs 54 of the second side 50 can be oriented to open on an opposite side 70 of the legs than the notches 36 in the legs 24 of the first side 20. In this way, the notches 36 of the legs 24 of the first side 20 can be inserted into the notches 66 of the legs 54 of the second side 50 to interlock the first side 20 with the second side 50.

When the notches 36 and 66 are inserted into one another, the first side 20 is oriented at an oblique angle A1 with respect to a support surface 8, such as the ground on which the raised box 10 rests. The second side 50 is also oriented at an oblique angle A2 with respect to the support surface.

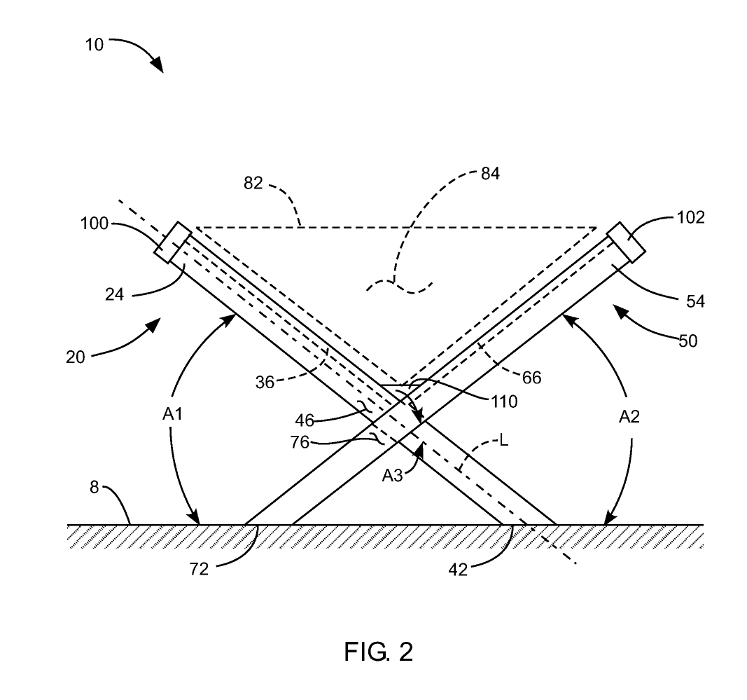

The oblique angle A1 of the first side 20 can be oriented substantially opposite the oblique angle A2 of the second side 50. In this way, the first side 20 can form an X-shape with the second side 50 with the legs 24 of the first side located under the panel 52 of the second side and the legs 54 of the second side located under the panel 22 of the first side, as best seen in FIG. 2.

Advantageously, the notches 36 and 66 can facilitate the oblique angle orientation of the first and second sides 20 and 50 with respect to the support surface 8. For example, as best seen in FIG. 5, in one aspect, the interlocking notch 36 on the first side 20 can include a mating surface 37 oriented at a predetermined angle A3 with respect to a longitudinal axis L of the legs 24. In one aspect the angle A3 can be between 30 and 50 degrees. The mating surface 37 can engage a corresponding mating surface 67 on an interlocking notch 66 from the second side 50 when the sides are joined together. The mating surfaces 37 and 67 of the interlocking notches 36 and 66 can facilitate orientation of the sides 20 and 50 at the oblique angles A1 and A2 with respect to the support surface 8. Additionally, the mating surfaces of the interlocking notches can bear the weight of the utility space 80 when the sides are joined together.

The notches 26 and 66 in the legs 24 and 54 of the first and second sides 20 and 50, respectively, can extend approximately half way through a width W of the legs. In one aspect, the width W can be between approximately 1.5 and 2.0 inches. The size of the notches with respect to the width W can facilitate a flush mating of the legs 24 and 54 at the location of the notches 26 and 66 when the legs are joined together via the notches. More specifically, edges 46 of the legs 24 of the first side 20 can be substantially flush with edges 76 of the legs 54 of the second side 50 when the legs are joined together via the notches.

When the two sides 20 and 50 are joined together via the interlocking notches 36 and 66, the quadrangular panel 22 of the first side and the quadrangular panel 52 of the second side can be positioned and oriented with respect to one another so as to form a utility space 80 in the space between the quadrangular panels. The utility space 80 can have a triangular cross section, indicated by dashed lines at 82, and a volume, indicated by dashed lines at 84, shaped as a triangular prism.

It is a particular advantage that the raised box 10 described herein does not have a flat bottom but rather has sides 20 and 50 that slope downward to a common vertex, indicated generally at 86. It will be appreciated that when used as a planter box that receives water to nourish plants, a raised box with a flat bottom can allow moisture to accumulate on the bottom surface inside the utility space. Such moisture accumulation can create mildew and mold that can inhibit and interfere with plant growth, and can also rot some materials that may be used in the construction of planter boxes. In contrast, the raised box device 10 described herein has quadrangular panels 22 and 52 that slope downward to a common vertex. The sloped sides 20 and 50 allow water and moisture to drain away from the panels 22 and 52 that form the utility space 80. Hence, the chance of mold or mildew forming is minimized, as is the potential for water to rot the material of the raised box, especially when used as a planter box.

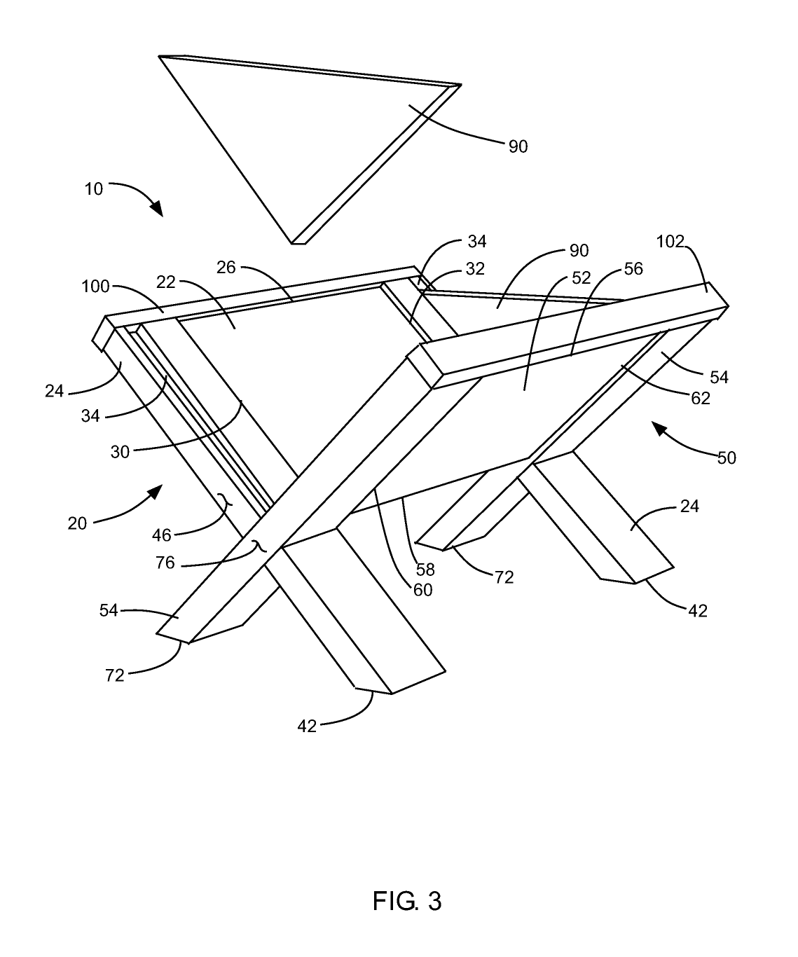

Turning to FIGS. 3-5, the raised box 10 can also include end panels 90 that can be sized and shaped to close the ends of the utility space 80. The quadrangular panel 22 of the first side 20 can have grooves 34 located near the opposite sides 30 and 32 of the panel 22. Similarly, the quadrangular panel 52 of the second side 50 can have grooves 64 located near the opposite sides 60 and 62 of the panel 52. Additionally, the grooves 34 in the quadrangular panel 22 of the first side 20 can be positioned to align with the grooves 64 in the quadrangular panel 52 of the second side 50 when the first and second sides are joined together via the interlocking notches 26 and 66.

Additionally, each of the pair of legs 24 and 54 can extend from an upper edge 26 and 56 of the quadrangular panels 22 and 52, respectively, to a distal end 42 and 72 away from a lower end 28 and 58 of the quadrangular panels 22 and 52, respectively. The grooves 34 and 64 can extend along the portion of the legs 24 and 54 that is adjacent the opposite ends of the quadrangular panels. An edge cap 100 and 102 can be coupled to the pair of legs 24 and 54 and the upper edge 26 and 56 of the quadrangular panels 22 and 52, respectively. The edge caps 100 102 can provide end stops to the grooves 34 and 64 to facilitate placement and retention of the end panels 90.

As best seen in FIGS. 5 and 10, the raised box 10 can also include a drain block 110. The drain block 110 can be sized and shaped to fit in a bottom 120 of the utility space 80 to close off a gap 122 between the quadrangular panel 22 of the first side 20 and the quadrangular panel 52 of the second side 50. The drain block 110 can have an elongated triangular prism shape with sides 112 and 114 that can rest against the quadrangular panels 22 and 52 to restrict soil, or other contents of the utility space 80 from falling through the gap 122, yet allow moisture and water to drain down the sloped sides of the utility space 80 and out the gap 122.

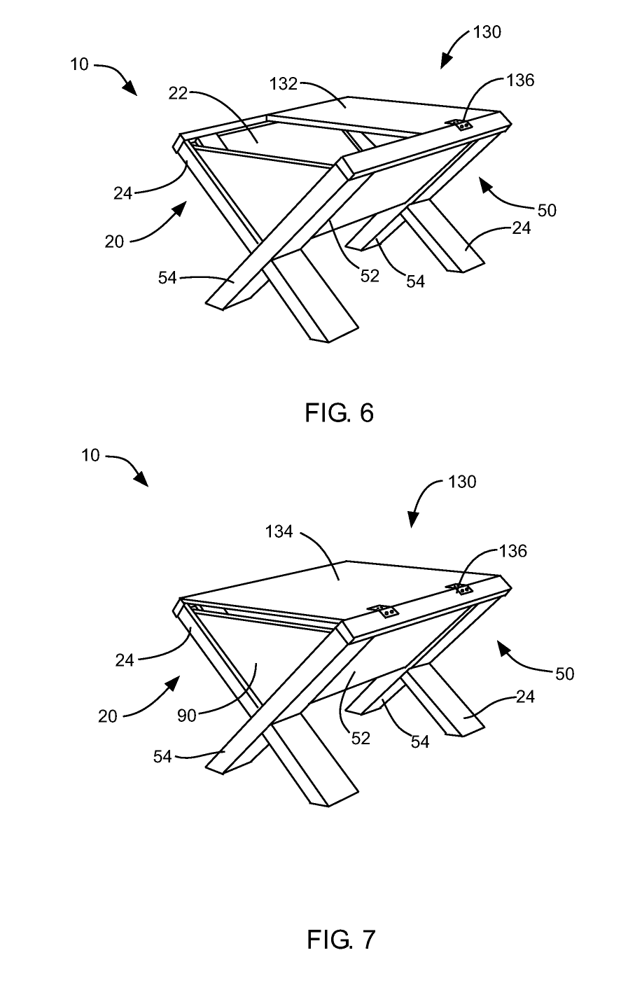

As seen in FIGS. 6-7, the raised box can also include a lid, indicated generally at 130. The lid 130 can be removably disposable on the uppermost edges 26 and 56 of the quadrangular panels 22 and 52 of the first and second sides 20 and 50, respectively. In one aspect, the lid 130 can be a partial lid 132 that can enclose a portion of the utility space 80 and form a bench seat on the raised box device 10 while allowing access to soil (not shown) within the utility space, as shown in FIG. 6. In another aspect, the lid can be a full lid 134 that can cover the entire utility space 80 and form a bench seat on the raised box device 10, as shown in FIG. 7.

In one aspect, as shown in FIGS. 6-7, the lid 130 can be attached with a hinge 136 to the raised box device 10. In another aspect (not shown), the lid can be removable without any fastener or hinge. Other types of connectors, as known in the art, can also be used to removably connect the lid to the raised box.

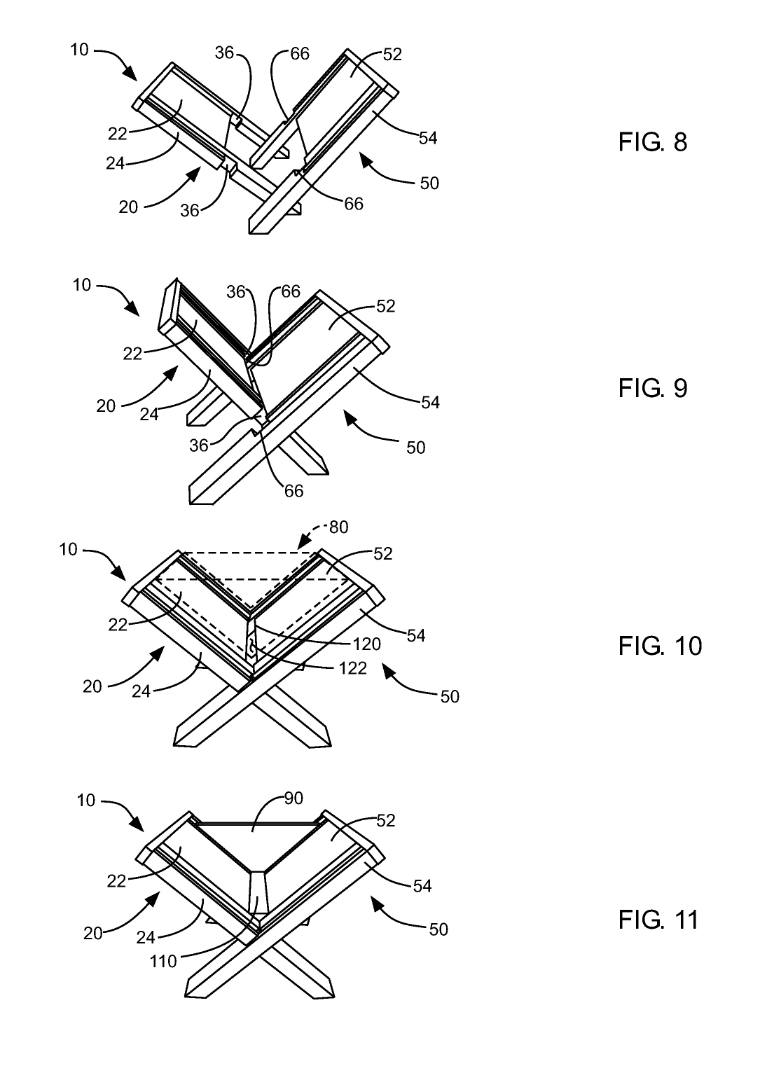

As illustrated in FIGS. 8-11, the present invention also provides a method for forming a raised box device 10 including positioning a first side 20 adjacent a second side 50, as shown in FIG. 8. Each of the first and second sides can include a quadrangular panel 22 and 52 and a pair of legs 24 and 54 extending from the quadrangular panel. Interlocking notches 36 and 66 in the pair of legs of the first can be aligned with corresponding notches in the pair of legs of the second side, as shown in FIG. 9. The first side 20 can be joined with the second side 50 by inserting the notches 36 on the pair of legs 24 of the first side 20 with the notches 66 on the pair of legs 54 of the second side into one another, as shown in FIG. 10. The first side 20 and the second side 50 can be oriented at oblique and opposing angles A1 and A2 with respect to a support surface (not shown) such that the quadrangular panels 22 and 52 can form a utility space 80 supported by the pairs of legs, as shown in FIGS. 10-11.

The method can also include placing a drain block 110 in the bottom 120 of the utility space 80, as shown in FIGS. 10-11. The drain block can be sized and shaped to fill a gap 122 formed between the quadrangular panel of the first side and the quadrangular panel of the second side when the first side is joined to the second side via the interlocking notches.

Additionally, the method can include placing end panels 90 on the raised box device 10 to partially enclose the utility space 80, as shown in FIGS. 10-11. In one aspect, the utility space can then be filled with soil (not shown) to form a garden bed such that the raised box can be used as a planter box.

The method can also include placing a quadrangular lid 130 on the first and second panels to further enclose the utility space, as best seen in FIGS. 6-7.

It will be appreciated that the raised box 10 shown in the FIGs and discussed herein can have several useful purposes. For example, as discussed above, the raised box 10 can be used as a raised planter box with the utility space forming a garden bed when filled with soil. Additionally, the raised box can be used as a storage bench when a lid is disposed over the utility space. Other possible uses of the raised box include a manger, a cradle, a tool bench, a toy box, and the like.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is provisionally claimed:

1. A raised box device, comprising:
a) a first side having a quadrangular panel and a pair of legs extending from the panel, each of the pair of legs having a notch opening on a similar side of the leg;
b) a second side having a quadrangular panel and a pair of legs extending from the panel, each of the pair of legs having a notch opening on a similar side of the leg and opposite the side of the legs of the first side; and
c) the notches of the legs of the first side being insertable into the notches of the legs of the second side to form a utility space between the quadrangular panels of the first and second sides.

2. The device of claim 1, wherein the utility space has a triangular cross section.

3. The device of claim 1, wherein the first side and second sides are oriented at oblique and opposing angles with respect to a support surface.

4. The device of claim 1, wherein the notches in the legs of the first and second sides extend approximately half way through a width of the legs so that an edge of the legs are substantially flush with one another when the legs are joined together via the notches.

5. The device of claim 1, further comprising:
an end panel coupleable to an end of the raised box to close an end of the utility space.

6. The device of claim 1, further comprising:
a) a groove located near an end of the quadrangular panel of the first side and a corresponding groove located near an end of the quadrangular panel of the second side, the grooves being positioned to align together when the first and second side are joined together; and
b) an end panel insertable into the grooves of the first and second sides, the end panel being sized and shaped to close an end of the utility space.

7. The device of claim 1, further comprising:
a drain block sized and shaped to fit in a bottom of the utility space to close off a gap between the quadrangular panel of the first side and the quadrangular panel of the second side.

8. The device of claim 7, wherein the drain block has an elongated triangular prism shape with sides that rest against the quadrangular panels of the first and second sides to close the gap.

9. The device of claim 1, further comprising:
a lid removably disposable on a top edge of the quadrangular panels of the first and second sides to enclose at least a portion of the utility space and form a bench seat on the raised box device.

10. The device of claim 1, wherein each of the pair of legs extends from an upper edge of the quadrangular panels to a distal end away from a lower end of the quadrangular panels.

11. The device of claim 10, further comprising:
a) an edge cap coupled to the pair of legs and the upper edge of the quadrangular panel.

12. A raised box device, comprising:
a) a pair of sides having legs joinable together by interlocking notches sized and shaped to angle each of the sides in an oblique angle with respect to a support surface and opposite the angle of the other side when the sides are joined together; and
b) the sides forming a utility space having a triangular cross section formed by the oblique angle orientation of the sides with respect to the support surface when the sides are joined together via the interlocking notches.

13. The device of claim 12, wherein the interlocking notches further includes a mating surface oriented at a predetermined angle with respect to a longitudinal axis of the legs of the side such that the mating surface engages a corresponding mating surface on an interlocking notch when the sides are joined together to:
i) orient the side in the oblique angle with respect to the support surface; and
ii) bear a weight of the utility space when the sides are joined together.

14. The device of claim 12, wherein the interlocking notches on one of the pair of sides faces opposite the interlocking notches on the other of the pair of sides.

15. The device of claim 12, wherein the interlocking notches on a first side of the pair of sides face a similar direction and the interlocking notches on a second side of the pair of sides faces a similar direction that is opposite the direction of the notches on the first side.

16. The device of claim 12, further comprising:
a pair of end panels having a triangular shape and disposable on opposite ends of the utility space formed when the pair of sides are joined together via the interlocking notches.

17. A method for forming a raised box, comprising
a) positioning a first side adjacent a second side, each of the first and second side having a quadrangular panel and a pair of legs extending from the quadrangular panel;
b) aligning interlocking notches in the pair of legs of the first side with corresponding notches in the pair of legs of the second side;
c) joining the first side with the second side by interlocking the notches on the pairs of legs; and
d) orienting the first side and the second side at oblique and opposing angles with respect to a support surface such that the quadrangular panels form a utility space supported by the pairs of legs.

18. The method of claim 17, further comprising:
a) placing a drain block in the bottom of the utility space, the drain block being sized and shaped to substantially fill a gap formed between the quadrangular panel of the first side and the quadrangular panel of the second side when the first side is joined to the second side via the interlocking notches.

19. The method of claim 17, further comprising:
a) placing end panels on opposite ends of the utility space to enclose the utility space; and
b) filling the utility space with soil to form a garden bed.

20. The method of claim 17, further comprising:
a) placing a lid on an upper edge of the first and second panels to further enclose the utility space.
